(19) United States
(12) Patent Application Publication
(10) Pub. No.: US 2018/0093237 A1
(43) Pub. Date: Apr. 5, 2018

(54) PURIFICATION APPARATUS AND PURIFICATION TREATMENT VEHICLE

(71) Applicant: KYB Corporation, Tokyo (JP)

(72) Inventors: Nobuo KATAHARA, Tokyo (JP); Masakazu NAKAZATO, Tokyo (JP); Atsusi NOTO, Tokyo (JP); Noboru TADAHIRA, Tokyo (JP); Tatsuru TORIYABE, Tokyo (JP); Terumi MORI, Tokyo (JP)

(73) Assignee: KYB Corporation, Tokyo (JP)

(21) Appl. No.: 15/565,954

(22) PCT Filed: Jun. 2, 2016
(86) PCT No.: PCT/JP2016/066376

§ 371 Date: Oct. 12, 2017

(30) Foreign Application Priority Data
Jun. 11, 2015 (JP) 2015-118308

(51) Int. Cl. B01F 9/02; B09C 1/02; B09C 1/08; B01F 9/08

(52) U.S. Cl. CPC B01F 9/025; B09C 1/02; B60P 3/00; B01F 9/08; B09C 1/08

(57) ABSTRACT

There is provided a purification apparatus that packages two apparatuses that respectively perform separation treatment and purification treatment into a single apparatus, to reduce a size of the apparatus and facilitate easier transportation to the site, and to improve a treatment amount of contaminated earth and sand per unit time. The purification apparatus includes a drum rotatable around an axis, a sieve having a cylindrical shape and being fixedly accommodated in the drum, a first blade having a spiral shape and being provided between the drum and the sieve, and the second blade having a spiral shape and being provided in the sieve. In the purification apparatus, soil charged into the sieve is separated with the sieve, only the contaminated earth and sand are gathered in a treatment tank between the drum and the sieve, and a chemical agent is introduced into the treatment tank for the purification treatment.

### TECHNICAL FIELD

The present invention relates to an apparatus for purifying sol containing harmful substances.

### BACKGROUND ART

In recent years, soil contamination caused by absorption of harmful substances such as polychlorinated biphenyl (PCB) into soil has become a social problem.

In order to cope with such soil contamination, for example, as disclosed in JP 2006-328679 A, there has been developed a purification apparatus having an earth-stone separator for separating earth and stones, an earth crusher for finely pulverizing earth separated by the earth-stone separator, and a spraying machine for spraying an insolubilizing agent for insolubilizing contaminants contained in the soil, to the pulverized earth.

According to this purification apparatus, the earth containing the contaminants separated by the earth-stone separator is charged into the earth crusher, finely pulverized by a pulverizing rotor while moving with the belt conveyor provided in the earth crusher, and then subjected to an insolubilization treatment by spraying the insolubilizing agent with the spraying machine.

### SUMMARY OF THE INVENTION

However, since the purification apparatus of Patent Literature 1 requires the earth-stone separator for separating contaminated earth and uncontaminated stones, and the spraying machine for performing purification treatment to purify the contaminated earth by spraying the chemical agent on the separated contaminated earth, the entire purification apparatus becomes large, and it is difficult to transport the apparatus.

Additionally, since the treatment must be performed with the subsequent spraying machine after finishing of the treatment with the earth-stone separator, the amount of the contaminated earth that can be treated per unit time is small, and the treatment takes time.

In view of the above, the present invention provides a purification apparatus that makes the apparatus compact, facilitates easier transportation to the site, and improves a treatment amount of contaminated earth and sand per unit time.

In order to achieve the above-mentioned object, a purification apparatus according to the present invention includes a drum, a sieve having a cylindrical shape and being fixedly accommodated in the drum, a first blade having a spiral shape and being provided between the drum and the sieve, and a second blade having a spiral shape and being provided in the sieve.

### BRIEF DESCRIPTION OF DRAWINGS

FIG. 1 is a conceptual diagram showing a purification treatment vehicle mounted with a purification apparatus according to the present embodiment.

FIG. 2 is a conceptual diagram showing a purification apparatus according to a first embodiment.

FIG. 3 is a conceptual diagram showing a purification apparatus according to a second embodiment.

### DESCRIPTION OF EMBODIMENTS

Hereinafter, the present invention will be described with reference to the drawings based on the illustrated present embodiment. The same reference numerals given throughout the several views indicate the same or corresponding parts.

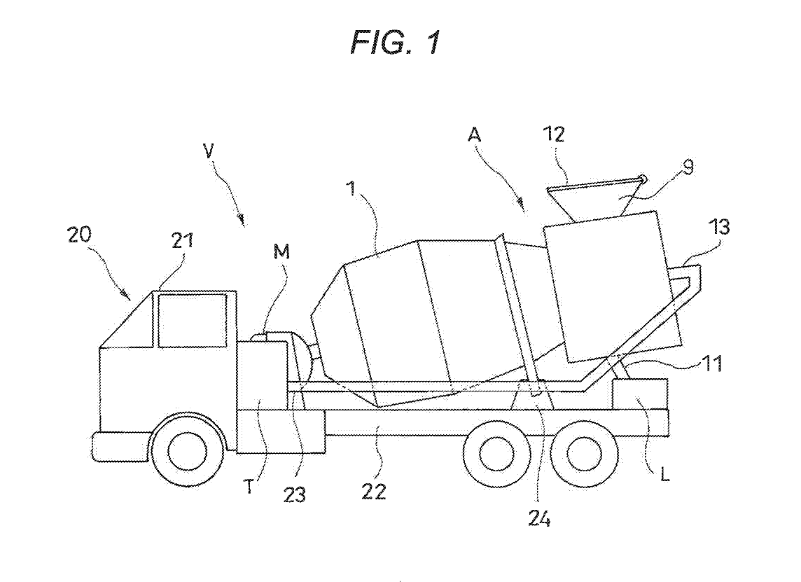

As shown in FIG. 1, in a purification treatment vehicle V according to the present embodiment, a drum 1 of a purification apparatus A is rotatably mounted on a frame 22 of a vehicle 20 having the frame 22.

Specifically, the vehicle 20 according to the present embodiment includes a vehicle body 21, the frame 22 provided on a rear side of the vehicle body 21, rollers 23 and 24 that rotatably support the drum 1 in the purification apparatus A at the rear of the frame 22, and a driving source M installed in a space between the vehicle body 21 and the purification apparatus A and connected to a front end of the drum 1. Then, the purification apparatus A is supported on the rollers 23 and 24 at the front and rear, and is mounted on the vehicle 20 while being inclined so as to lift a rear end of the purification apparatus A. Thus, the drum 1 of the purification apparatus A is mounted on the frame 22 of the vehicle 20 so as to be rotatable around an axis, and the drum 1 can be rotationally driven by the driving source M.

As shown in FIG. 1, in the present embodiment, in the space between the vehicle body 21 and the purification apparatus A, a chemical tank 2 containing a chemical agent for purifying contaminated earth and sand as an object to be purified is installed, and a sealed storage tank L is installed on the frame 22 on the rear side of the purification apparatus. The arrangement of the chemical tank T and the storage tank L is not particularly limited, and they may be arranged in an appropriate space.

### First Embodiment

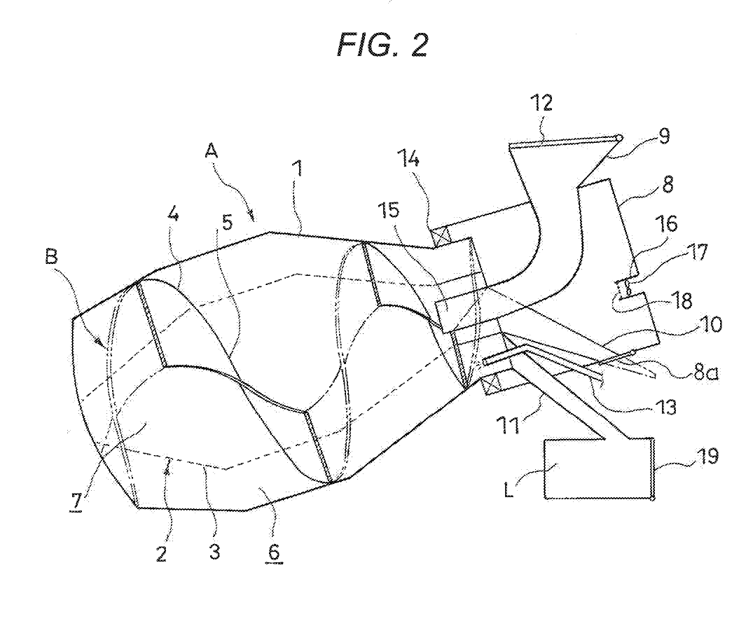

Hereinafter, the purification apparatus A according to a first embodiment will be described in detail. As shown in FIG. 2, a purification apparatus A includes a drum 1, a sieve 2 having a cylindrical shape and being fixedly accommodated in the drum 1, a first blade 4 provided in a treatment tank 6 between the drum 1 and the sieve 2, and a second blade 5 provided in a separation tank 7 in the sieve 2. Here, the first blade 4 and the second blade 5 are formed integrally with a wide long blade B fixed to an inner wall of the drum 1.

The drum 1 is formed in a bottomed cylindrical shape having an opening at a rear end, and the shaft center portion of the bottom portion, which is a front end, is connected to the driving source M. The drum 1 is rotatable around the axis by driving the driving source M. In this case, the driving source N is a hydraulic motor, and a hydraulic pump (not shown) that supplies hydraulic pressure to the hydraulic motor is configured to receive power from an engine of the vehicle (20) via a power take-off (PTO). In addition to the hydraulic motor, an electric motor may be used as the driving source M.

The sieve 2 has a cylindrical shape and is fixedly accommodated in the drum 1 with a front end fixed and closed on the bottom portion of the drum 1, and with a rear end opened without being closed. Further, the sieve 2 is entirely provided with a large number of holes 3. A size of the holes 3 is set such that gravel and contaminated earth and sand can be sieved from the charged soil. Therefore, it is advisable to set a diameter of the holes 3 to be equal to or smaller than a particle diameter of the gravel to be removed.

Further, since the sieve 2 is fixed to the drum 1, the sieve 2 rotates around an axis along with rotation of the drum 1.

The first blade 4 is a spiral blade fixedly provided on the inner wall of the drum 1. During forward, rotation of the drum 1, the first blade 4 carries contaminated earth and sand in the treatment tank 6 to the front end side of the drum 1, and carries to the rear end side of the drum 1 during reverse rotation.

The second blade 5 is a spiral blade fixedly provided on the inner wall of the sieve 2. During forward rotation of the sieve 2, the second blade 5 carries the gravel in the separation tank 7 to the front end side of the sieve 2, and carries to the rear end side of the sieve 2 during reverse rotation.

Further, in the present embodiment, the first blade 4 and the second blade 5 are formed by the wide long blade B fixed to the inner wall of the drum 1, and the sieve 2 is formed by a spiral steel plate bridged in the long blade B. In other words, the first blade 4 is formed by a portion of the long blade B, arranged between the drum 1 and the sieve 2, and the second blade 5 is formed by a portion of the long blade B, arranged in the sieve 2. This eliminates necessity of providing the sieve 2 with strength for supporting the second blade 5, and allows the sieve 2 to be formed in a cylindrical shape by bridging, rather than a steel plate, a metal wire net or a band-shaped body knitted like a cage so as to allow passage of earth and sand, to the long blade B as described above. Since the sieve 2 may have any structure as long as only the contaminated earth and sand can be sieved into the treatment tank 6, forming the first blade 4 and the second blade 5 with the single long blade B improves a degree of freedom of a structure of the sieve 2, allowing various structures to be adopted for the sieve 2. It is also possible that the first blade 4 is provided on the inner wall of the drum 1, the sieve 2 having a cylindrical shape is attached to the inner circumference of the first blade 4, the second blade 5 is attached to the inner periphery of the sieve 2, and the first blade 4 and the second blade 5 are separately and independently provided. In this way, when the first blade 4 and the second blade 5 are separately and independently provided, the second blade 5 can be formed to be suitable for separating contaminated earth and sand from gravel, while the first blade 4 can be formed to be suitable for agitating contaminated earth and sand with the chemical agent, providing an advantage that a blade suitable for each application can be provided.

Since a volume of the treatment tank 6 is determined by a relationship between sizes of the drum 1 and the sieve 2, the sizes of the drum 1 and the sieve 2 can be set according to a required volume of the treatment tank 6.

As shown in FIG. 2, the purification apparatus A according to the present embodiment includes a box-like closing member 8 that closes a rear end opening of the drum 1 and the sieve 2, a hopper 9 that is provided at an upper end of the closing member 8, and has a funnel shape to be convenient for charging soil into the sieve 2. Further, as shown in FIG. 1, a hopper cover 12 capable of opening and closing a charging port of a hopper 9 is also provided.

In addition, a seal 14 is provided in an annular gap between the closing member 8 and the drum 1, so that even when the drum 1 rotates with respect to the closing member 8, the gap between the closing member 8 and the drum 1 is to be sealed. Therefore, when the charging port of the hopper 9 is sealed with the hopper cover 12, the closing member 8 and inside the drum 1 are sealed.

The hopper cover 12 according to the present embodiment may be a detachable cover removable from the hopper 9, and a structure is not limited to that illustrated and described, as long as the hopper 9 can be sealed by opening and closing the charging port of the hopper 9.

Further, the hopper 9 has a seal pipe 15 to be inserted into the sieve 2, and the seal pipe 15 is disposed so as not to interfere with the second blade 5 provided in the sieve 2.

Further, the closing member 8 is provided with an exhaust port 16 communicating with outside air, a fan 17 that is installed in the exhaust port 16, and sucks gas from inside the drum 1 and the closing member 8 to exhaust the gas toward outside, and a filter 18 provided on an inner side than the fan 17 in the exhaust port 16. In performing a charging work for charging soil into the hopper 9, when the charging work is performed with the fan 17 being driven, even if dust rises from the soil charged into the hopper 9, the fan 17 causes the dust to be sucked into the closing member 8, to prevent the dust from scattering outside. Since the airflow sucked and exhausted by the fan 17 passes through the filter 18, even if contaminated earth and sand are mixed in the airflow, the filter 18 can catch the contaminated earth and sand, to prevent from leaking outside. Providing the exhaust port 16, the filter 18, and the fan 17 in the closing member 8 in this manner can prevent the dust including the contaminated earth and sand from scattering outside when the soil is charged into the hopper 9, no that the purification work can be safely performed.

The purification apparatus A according to the present embodiment is provided with piping in which one end is communicated with the chemical tank T that accommodates the chemical agent, and another end is communicated with an introduction nozzle 13 disposed in the treatment tank 6 of the drum 1. When the chemical agent is liquid, a pump is provided in the middle of the piping, and when the chemical agent is powder and granule, there is provided a compressor or the like for fluidizing the chemical agent and sending the chemical agent from inside the chemical tank T toward the introduction nozzle 13.

The introduction nozzle 13 extends from the outside through the closing member 8 to between the drum 1 and the sieve 2, and the introduction nozzle 13 is disposed at a position where the injection port at a tip faces the treatments tank 6 and does not interfere with the first blade 4.

Here, for example, in decomposing POE, there may be used microbial preparation that decomposes harmful substances by action of microorganisms, an oxidizing agent such as a Faenton's reagent (hydrogen peroxide and iron solution) that decomposes and purifies harmful substances by action of oxidizing effect, or a slurry iron powder (SI) that decomposes harmful substances into harmless substances, as the chemical agent. When a purpose of soil remediation is insolubilization of heavy metals, those containing schwertmannite, jarosite, ferrihydrite, or the like are used as the chemical agent. In other words, the chemical agent can be freely selected according to the types of harmful substances contained in the soil and purification purposes.

Furthermore, the purification apparatus A according to the present embodiment includes a first chute 10 and a second chute 11, which serve as discharge ports, respectively at rear ends of the treatment tank 6 and the separation tank 7. As shown in FIG. 2, the first chute 10 provided on the separation tank 7 side can extend outside from the opening/closing door 8a provided on the closing member 8, as indicated by a dashed line, so as to be able to discard the gravel separated by the sieve 2 to outside. An opening/closing door 8a is closed in a state where purification treatment is being performed, and is opened to allow the first chute 10 to extend outside when the drum 1 is reversed to discharge the gravel from the sieve 2. Since the second chute 11 is tubular, and receives the earth and sand discharged from the rear end of the drum 1 to send the earth and sand to the storage tank L, the second chute 11 obliquely extends toward the opening of the storage tank L from the rear end of the drum 1. In the storage tank L, the opening is connected to the second chute 11, and there is provided a discharge port 19 that enables discharge of earth and sand after the purification treatment stored inside, to outside.

Hereinafter, an operation of the purification apparatus A according to the present embodiment will be described. First, soil containing harmful substances is charged from the hopper 9 through the seal pipe 15 into the separation tank 7, which is an inside of the sieve 2 that rotates forward together with the drum a with the driving source M. The forward rotational drive of the drum 1 with the driving source M is continued during the purification treatment. Upon entry of the soil, the charging port of the hopper 9 is opened, and sealed by the hopper cover 12 when the charging of the soil is completed. During the charging of the soil, the fan 17 is driven to prevent dust containing contaminated earth and sand from scattering outside of the apparatus. In the case where the fan 17 is constantly driven without stopping during treatment, scattering of dust can be prevented, so that the purification treatment can be performed without sealing the charging port of the hopper 9 with the hopper cover 12. However, when the charging port of the hopper 9 is sealed with the hopper cover 12, the safety during treatment is further enhanced.

Harmful substances that contaminate soil penetrate earth and sand such as soil and gravel with a fine particle diameter, but are hard to penetrate into large grains like rocks such as pebbles and stones. The charged soil is agitated while being transferred to the front end side of the sieve 2 by the second blade 5 provided in the sieve 2. The soil is separated into gravel and contaminated earth and sand by transferring and agitating with the second blade 5, and contaminated earth and sand with a small particle diameter pass through the holes 3 provided in the sieve 2, to move into the treatment tank 6. Therefore, uncontaminated gravel having a relatively large particle diameter cannot pass through the holes 3, and remains in the sieve 2. In this way, the gravel is removed from the soil by the sieve 2 and the second blade 5, and only the contaminated earth and sand, are separated and sent to the treatment tank 6.

Also, depending on the transferring and agitating with the second blade 5, since pieces of the gravel attached with the contaminated earth and sand on surfaces collide with each other, the contaminated earth and sand attached to the gravel are also peeled off and sent to the treatment tank 6.

To the contaminated earth and sand separated from the gravel and sent into the treatment tank 6, the chemical agent is injected from the introduction nozzle 13. The chemical agent introduced into the treatment tank 6, and the contaminated earth and sand are agitated while being transferred to the front end of the drum 1 by the first blade 4 due to the forward rotation of the drum 1. Therefore, the contaminated earth and sand and the chemical agent are kneaded in the treatment tank 6. As a result, only the contaminated earth and sand in the soil efficiently come into contact with the chemical agent, and the contaminated earth and sand are efficiently purified. Thus, in the purification apparatus A, it is possible to simultaneously perform two treatments; the separation treatment for charging soil into the sieve 2 to separate the gravel from the contaminated earth and sand, and the purification treatment for agitating the chemical agent and contaminated earth and sand.

When the drum 1 is reversely rotated after completion of the purification treatment, the contaminated earth and sand after the purification are transferred to the rear end of the drum 1 by the first blade 4, and the gravel is transferred to the rear end of the sieve 2 by the second blade 5. Then, the contaminated earth and sand, and the gravel are discharged separately from the drum 1 and the sieve 2, through the first chute 10 and the second chute 11 provided at the rear ends of the drum 1 and the sieve 2.

At this time, the gravel remaining in the separation tank 7 is discharged outside of the apparatus through the first chute 10, by opening the opening/closing door 8a of the closing member 8, and extending the first chute 10 out of the closing member 8. Whereas, the purified contaminated earth and sand accommodated in the treatment tank 6 are sent to the storage tank L by using the second chute 11, and are temporarily stored in this storage tank L. If the contaminated earth and sand after purification can be disposed at the site, the contaminated earth and sand may be discharged outside of the apparatus. In this case, a separate opening/closing door may be provided on the closing member 8 such that the second chute 11 can be extended outside, to enable the earth and sand to be discharged outside.

As described above, the purification apparatus 21 according to the present embodiment includes the drum 1 rotatable around the axis, the sieve 2 having a cylindrical shape and being fixedly accommodated in the drum 1, the first blade 4 having a spiral shape and being provided between the drum 1 and the sieve 2, and the second blade 5 having a spiral shape and being provided in the sieve 2. Therefore, according to the purification apparatus A of the present invention, when the drum 1 is rotationally driven to charge the soil into the sieve 2, the gravel with a large particle diameter is sieved into the sieve 2, and the contaminated earth and sand with a small particle diameter are sieved into the treatment tank 6 between the drum 1 and the sieve 2. Furthermore, it is possible to introduce the chemical agent into this treatment tank 6 and knead the contaminated earth and sand with the chemical agent, to purify the contaminated earth and sand.

Therefore, since it is possible to perform two treatments with one apparatus, which are the treatment for separating the soil into uncontaminated gravel and contaminated earth and sand, and the purification treatment, the purification apparatus A can be downsized.

Further, according to this purification apparatus A, the separation of uncontaminated gravel and contaminated earth and sand in the separation tank 7, and the purification treatment in the treatment tank 6 can be simultaneously performed in each tank.

In this way, since the two treatments of the separation treatment and the purification treatment can be performed simultaneously, an amount of the purification treatment of contaminated earth and sand per unit time is improved, so that the purification treatment can be performed for soil in large quantities in a short time.

Further, the purification apparatus A according to the present embodiment includes the introduction nozzle 13 that introduces the chemical agent into the treatment tank 6 between the drum 1 and the sieve 2. Therefore, it is possible to introduce the chemical agent directly into the treatment tank 6 where only the contaminated earth and sand separated from the soil have been sieved, allowing efficient purification treatment of only the contaminated earth and sand containing harmful substances.

Further, in the purification apparatus A according to the present embodiment, the inside the sieve 2 serves as the separation tank 7, the first chute 10 and the second chute 11 through which the contents are discharged are respectively provided in the separation tank 7 and the treatment tank 6, and the second chute 11 on the treatment tank 6 side is communicated with the sealed storage tank L. Therefore, it is possible to temporarily store the contaminated earth and sand subjected to the purification treatment in the treatment tank 6, in the sealed storage tank L, and to discard the contaminated earth and sand after checking the safety, so that work can proceed more safely.

Further, in the purification apparatus P according to the present embodiment, the long blade B having a spiral shape is fixedly provided on the inner wall of the drum 1, and the sieve 2 is attached to the long blade B and provided in the drum 1. In the long blade B, from the drum fixing side to the sieve 2 is defined as the first blade 4, and from the sieve 2 to an end of the long blade B is defined as the second blade 5. In this way, when the first blade 4 and the second blade 5 are formed by the one long blade, and the sieve 2 is provided to be attached to the long blade B, it is not necessary for the sieve 2 to support the second blade 5, as compared with the case where the second blade 5 is fixed to the inner wall of the sieve 2. Therefore, the strength of the sieve 2 can be low, and the sieve 2 can be formed in a mesh or the like, improving the degree of freedom of the structure of the sieve 2.

The purification apparatus A according to the present embodiment includes the closing member 8 that closes an opening end of the drum 1 and the sieve 2, the hopper 9 provided to the closing member 8, and the hopper cover 12 capable of sealing the charging port of the hopper 9. As a result, the hopper 9 as the charging port into the drum 1 is sealed, eliminating possibility of leakage of dust from the hopper 9 even if dust rises in the drum 1.

Further, the invention according to the present embodiment is the purification treatment vehicle V including the frame 22 that rotatably supports the drum 1, the driving source M that rotationally drives the drum 1, and the vehicle 20 having the frame 22. The purification apparatus A is mounted on the vehicle 20, which facilitates easier movement of the purification apparatus A to a work site, to enable on-site treatment. In addition, since the drum 1 is rotationally driven by using the driving source M provided to the vehicle 20, the purification apparatus A can be operated while being mounted on the vehicle.

Although the purification apparatus A can be operated while being mounted on the vehicle 20 in the present embodiment, the purification apparatus A may be a placing type by preparing another driving source such as an electric motor. In the case of the placing type, the purification treatment apparatus is carried to the work site by a trailer or the like, to enable the onsite treatment. In this case, even if the work takes days, it is possible to leave the purification apparatus A in the work site and return only the tractor from the work site.

The purification apparatus A according to the present embodiment is provided with the exhaust port 16 communicating with outside air at the closing member 8, the fan 17 that is installed in the exhaust port 16, and sucks gas from inside the drum 1 and the closing member 8 to exhaust the gas toward outside, and the filter 18 provided on an inner side than the fan 17 in the exhaust port 16.

As a result, the air inside the purification apparatus A is sent out to the outside air side by the fan 17, so that inside the purification apparatus A becomes a negative pressure, which can prevents the contaminated earth and sand from leaking out together with air from the charging port of the hopper 9 or a gap between the drum 1 and the closing member 8. Further, even if the contaminated earth and sand are mixed in the air flow sent out to the outside air side by the fan 17, since the filter 18 is provided to the exhaust port 16, the structure prevents the contaminated earth and sand from leaking to the outside air side.

### Second Embodiment

Next, a purification apparatus C according to a second embodiment will be described. Here, the differences from the purification apparatus A according to the above-described, first embodiment will be mainly described, and the same reference numerals are given to the configurations having similar functions to omit the explanation.

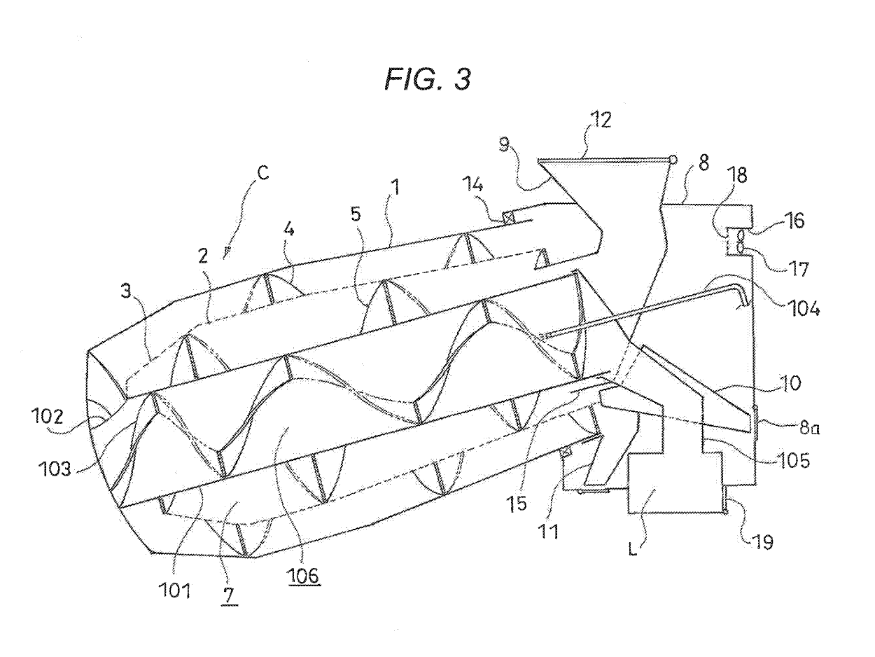

As shown in FIG. 3, in the purification apparatus C according to the present embodiment, an inner cylinder 101 is inserted into a sieve 2, and a front end of the inner cylinder 101 is connected to a drum 1 and accommodated in the drum 1. The front-end of the sieve 2 is joined to an outer periphery of the inner cylinder 101, and at a front end of the inner cylinder 101, an inlet 102 opened between the sieve 2 and the drum 1 is provided. In the purification apparatus C of the second embodiment, an inside of the inner cylinder 101 serves as a treatment tank 106.

In the inner cylinder 101, a third blade 103 having a spiral shape is provided, and the third blade 103 is provided in the same direction as a first blade 4 and a second blade 5, so that when the drum 1 rotates forward, contaminated earth and sand inside the inner cylinder 101 are transferred to the front end side. When the drum 1 is reversely rotated, the contaminated earth and sand are discharged from inside the inner cylinder 101 to outside.

In the present embodiment, since the inside of the inner cylinder 101 is a treatment tank 106, as shown in FIG. 3, there is provided an introduction nozzle 104 that can introduce a chemical agent into the inner cylinder 101. The introduction nozzle 101 extends from outside through a closing member 8 into the inner cylinder 101 serving as the treatment tank 106, and is arranged at a position where the injection port at a tip faces the treatment tank 106 and does not interfere with the third blade 103.

At a rear end of the inner cylinder 101, as shown in FIG. 3, a third chute 105 is provided for sending earth and sand into a storage tank L. The third chute 105 is arranged so as to be able to receive the earth and sand discharged from an opening end of the inner cylinder 101.

As shown in FIG. 3, since the opening at the rear end of the inner cylinder 101 is to be covered with the hopper 9 and the seal pipe 15, the third chute 105, which sends the earth and sand discharged from a rear end opening of the inner cylinder 101 to the storage tank L, needs to penetrate the hopper 9. Specifically, the third chute 105 has a tubular shape for the portion disposed inside the seal pipe 15, to prevent the earth and sand after the purification treatment from being mixed into the soil to be charged into the hopper 9 and the seal pipe 15. Therefore, the soil charged from the hopper 9 passes through an outer periphery of the inner cylinder 101 and an outer periphery of the tubular portion of the third chute 105 in the seal pipe 15, to enter the sieve 2.

An operation of the purification apparatus C according to the second embodiment will be described. First, soil containing harmful substances is charged from the hopper 9 through the seal pipe 15 into the separation tank 7, which is inside the sieve 2 that rotates forward together with the drum 1 with a driving source M.

Then, the charged soil is agitated while being transferred to the front end side of the sieve 2 by the second blade 5 provided in the sieve 2. The soil is separated into gravel and contaminated earth and sand by transferring and agitating with the second blade 5, and then the contaminated earth and sand with a small particle diameter pass through the holes 3 provided in the sieve 2, to move into a tank between the drum 1 and the sieve 2. Therefore, the uncontaminated gravel having a relatively large particle diameter cannot pass through the holes 3, and remains in the sieve 2. In this way, the gravel is removed from the soil by the sieve 2 and the second blade 5, and only the contaminated earth and sand can be separated.

The separated contaminated earth and sand are agitated and transported by the first blade 4 to an upper part of the inlet 102 of the inner cylinder 101 opened to the front end side of the drum 1, and accommodated in the inner cylinder 101 from the inlet 102.

To the contaminated earth and sand sent into the inner cylinder 101 as the treatment tank 106, the chemical agent is injected from the introduction nozzle 104. The chemical agent introduced into the treatment tank 106 and the contaminated earth and sand are agitated while being transferred to the front end of the inner cylinder 101 by the third blade 103 due to the forward rotation of the drum 1. Therefore, contaminated earth and sand and the chemical agent are kneaded in the treatment tank 106. As a result, only the contaminated earth and sand in the soil efficiently come into contact with the chemical agent, and the contaminated earth and sand are efficiently purified. Thus, in the purification apparatus C, is also possible to simultaneously perform two treatments; the separation treatment for charging soil into the sieve 2 to separate the gravel from the contaminated earth and sand, and the purification treatment for agitating the chemical agent and contaminated earth and sand.

When the drum 1 is reversely rotated after completion of the purification treatment, the gravel is transferred to the rear end of the sieve 2 by the second blade 5, and the contaminated earth and sand after the purification are transferred to the rear end of the inner cylinder 101 by the third blade 103. The gravel and the earth and sand transported to the rear ends of the sieve 2 and the inner cylinder 101 are discharged separately from the sieve 2 and the inner cylinder 101, through the first chute 10 and the third chute 105 provided respectively at the rear ends of the sieve 2 and the inner cylinder 101.

At this time, the gravel remaining in the separation tank 7 is discharged outside of the apparatus through the first chute 10, by opening the opening/closing door 8a of the closing member 8, and extending the first chute 10 out of the closing member 8.

Whereas, the purified contaminated earth and sand accommodated in the treatment tank 106 are sent to the storage tank L by using the third chute 105, and are temporarily stored in this storage tank L. If the contaminated earth and sand after purification can be disposed at the site, the contaminated earth and sand may be discharged outside of the apparatus. In this case, a separate opening/closing door may be provided on the closing member 8 such that the third chute 105 can be extended outside, to enable the earth and sand to be discharged outside.

Even if the contaminated earth and sand remain in the tank between the drum 1 and the sieve 2 without being sent into the inner cylinder 101, the contaminated earth and sand are discharged outside through the second chute 11. However, since the contaminated earth and sand remaining in the tank between the drum 1 and the sieve 2 have not been purified, the chemical agent may be sprayed in the tank between the drum 1 and the sieve 2, or a sealed container may be connected or the like with the second chute 11 to store the contaminated earth and sand in the sealed container, and then the purification treatment may be performed by kneading with the chemical agent.

As described above, the purification apparatus C according to the present embodiment includes the inner cylinder 101 inserted into the sieve 2 and having the inlet 102 opened between the sieve 2 and the drum 1, and the front and of the inner cylinder 101 is connected to the drum 1. This ensures prevention of remaining of the contaminated earth and sand without being sorted in the sieve 2 as the separation tank 7, as the contaminated earth and sand accumulate at the front end of the drum to prevent the particularly front end side of the sieve 2 from functioning as the separation tank 7.

Further, since the third blade 103 having a spiral shape is provided in the inner cylinder 101, the chemical agent and the contaminated earth and sand can be kneaded during the forward rotation of the drum 1, and the purified contaminated earth and, sand in the inner cylinder 101 can be discharged during the reverse rotation of the drum 1.

It should be noted that the third blade 103 having a spiral shape may be an inverted blade with respect to the first blade 4 and the second blade 5. In the case of the reverse blade, the contaminated earth and sand fed from the inlet 102 during the forward rotation can be transferred to the rear end side of the inner cylinder 101. In this case, when the drum 1 is forwardly rotated, the earth and sand subjected to the purification treatment is sequentially discharged to the storage tank L from the inner cylinder 101 serving as the treatment tank 106. Therefore, even if soil is continuously charged from the hopper 9, the contaminated earth and sand, and gravel are sequentially separated by the sieve 2, the contaminated earth and sand separated and sent into the inner cylinder 101 and the chemical agent are agitated and transferred by the third blade 103, and the earth and sand after the purification treatment are discharged from the rear end opening of the inner cylinder 101. In this way, the purification treatment of the contaminated earth and sand can be continuously performed without interruption.

In the purification apparatus C according to the present embodiment, the inner cylinder 101 serves as the treatment tank 106, and there is provided the introduction nozzle 104 that introduces the chemical agent into the treatment tank 106. Therefore, it is possible to directly introduce the chemical agent to the treatment tank 106 containing only the contaminated earth and sand separated from the soil, and to efficiently perform the purification treatment for only the contaminated earth and sand containing harmful substances

This application claims priority based on Japanese Patent Application No. 2015-118308 filed on Jun. 1, 2015, the content of which is incorporated herein by reference in its entirety.

1. A purification apparatus comprising:
a drum rotatable around an axis;
a sieve having a cylindrical shape and being fixedly accommodated in the drum, wherein an object to be purified can be charged inside the sieve;
a first blade having a spiral shape and being provided between the drum and the sieve; and
a second blade having a spiral shape and being provided in the sieve.

2. The purification apparatus according to claim 1, further comprising:
an inner cylinder that is inserted in the sieve, has a front end connected to the drum, and has an inlet opened between the sieve and the drum; and
a third blade having a spiral shape and being provided in the inner cylinder.

3. The purification apparatus according to claim 1, wherein
between the drum and the sieve serves as a treatment tank, and there is provided an introduction nozzle that introduces a chemical agent into the treatment tank.

4. The purification apparatus according to claim 2, wherein
an inside of the inner cylinder serves as a treatment tank, and there is provided an introduction nozzle that introduces a chemical agent into the treatment tank.

5. The purification apparatus according to claim 3, wherein
an inside of the sieve serves as a separation tank, a chute through which contents are discharged is provided in each of the separation tank and the treatment tank, and the chute on the treatment tank side is communicated with a sealed storage tank.

6. The purification apparatus according to claim 1, wherein
a long blade having a spiral shape is fixedly provided on an inner wall of the drum,
the sieve is attached to the long blade and provided in the drum,
from the drum fixing side to the sieve, in the long blade, is defined as the first blade, and
from the sieve to an end of the long blade is defined as the second blade.

7. The purification apparatus according to claim 1, further comprising:
a closing member that closes an opening end of the drum and the sieve;
a hopper provided to the closing member; and
a hopper cover capable of sealing a charging port of the hopper.

8. A purification treatment vehicle comprising:
the purification apparatus according to claim 1;
a frame that rotatably supports the drum;
a driving source that rotationally drives the drum; and
a vehicle having the frame.

9. The purification apparatus according to claim 4, wherein
an inside of the sieve serves as a separation tank, a chute through which contents are discharged is provided in each of the separation tank and the treatment tank, and the chute on the treatment tank side is communicated with a sealed storage tank.

10. The purification apparatus according to claim 2, wherein
a long blade having a spiral shape is fixedly provided on an inner wall of the drum,
the sieve is attached to the long blade and provided in the drum,
from the drum fixing side to the sieve, in the long blade, is defined as the first blade, and
from the sieve to an end of the long blade is defined as the second blade.

11. The purification apparatus according to claim 3, wherein
a long blade having a spiral shape is fixedly provided on an inner wall of the drum,
the sieve is attached to the long blade and provided in the drum,
from the drum fixing side to the sieve, in the long blade, is defined as the first blade, and
from the sieve to an end of the long blade is defined as the second blade.

12. The purification apparatus according to claim 4, wherein
a long blade having a spiral shape is fixedly provided on an inner wall of the drum,
the sieve is attached to the long blade and provided in the drum,
from the drum fixing side to the sieve, in the long blade, is defined as the first blade, and
from the sieve to an end of the long blade is defined as the second blade.

13. The purification apparatus according to claim 2, further comprising:
a closing member that closes an opening end of the drum and the sieve;
a hopper provided to the closing member; and
a hopper cover capable of sealing a charging port of the hopper.

14. The purification apparatus according to claim 3, further comprising:
a closing member that closes an opening end of the drum and the sieve;
a hopper provided to the closing member; and
a hopper cover capable of sealing a charging port of the hopper.

15. The purification apparatus according to claim 4, further comprising:
a closing member that closes an opening end of the drum and the sieve;
a hopper provided to the closing member; and
a hopper cover capable of sealing a charging port of the hopper.

16. A purification treatment vehicle comprising:
the purification apparatus according to claim 2;
a frame that rotatably supports the drum;
a driving source that rotationally drives the drum; and
a vehicle having the frame.

17. A purification treatment vehicle comprising:
the purification apparatus according to claim 3;
a frame that rotatably supports the drum;
a driving source that rotationally drives the drum; and
a vehicle having the frame.

18. A purification treatment vehicle comprising:
the purification apparatus according to claim 4;
a frame that rotatably supports the drum;
a driving source that rotationally drives the drum; and
a vehicle having the frame.
